(19) United States
(12) Patent Application Publication
(10) Pub. No.: US 2011/0033727 A1
(43) Pub. Date: Feb. 10, 2011

(54) BOOKBINDING WIRE OR PAPERCLIP WIRE WITH DEGRADABLE, BIODEGRADABLE AND/OR COMPOSTABLE COATING

(75) Inventors: André Grob, Singapore (SG); Peter Poelman, Velzeke (BE); Alain Leplae, Moorsele (BE)

Correspondence Address: FOLEY AND LARDNER LLP;SUITE 500, 3000 K STREET NW, WASHINGTON, DC, 20007, US

(73) Assignee: NV BEKAERT SA

(21) Appl. No.: 12/988,594

(22) PCT Filed: Apr. 20, 2009
(86) PCT No.: PCT/EP09/02863

§ 371 Date: Oct. 19, 2010

(30) Foreign Application Priority Data
Apr. 21, 2008 (EP) 08154845.5

(51) Int. Cl. B32B 15/02; B32B 15/04; D02G 3/00; C01G 49/06

(52) U.S. Cl. 428/624; 428/375; 428/379; 423/633

(57) ABSTRACT

This application relates to the use of a wire comprising a coating of a bio plastics material as a bookbinding wire or paperclip. The coating is a closed coating offering the wire a good corrosion protection when exposed at normal ambient conditions during use as bookbinding wire or as paperclip and the coating is degradable, biodegradable or compostable once said wire is exposed to an environment suitable for decomposition of said coating. More particularly, the application relates to the use of and to a bookbinding wire and paperclip with a PLA coating. The application further relates to a method for recycling said bookbinding wires and paperclips.

### TECHNICAL FIELD

The invention relates to the use of a steel wire provided with a coating of a bio plastics material as bookbinding wire or paperclip. The invention also relates to a bookbinding wire or paperclip provided with a coating of a bio plastics material. More particularly, the invention relates to the use of and to a bookbinding wire and paperclip provided with a PLA coating.

The invention further relates to a method for environmentally safe recycling said bookbinding wire or paperclip.

### BACKGROUND ART

Steel wires provided with an extrudable polymer coating, such as polyvinylchloride or polyester, are generally known in the art. WO-A-2007/060040 by Applicant describes a steel wire with thick polymer coating for use as a bookbinding wire. The wire combines the elasticity of a pure polymer wire with the mechanical advantages of a steel wire, with a considerable reduction in weight.

Bookbinding wires are used in many applications. Disposal after use creates a serious waste problem. Most polymer coatings, such as polyvinylchloride and polyester, are not or not fully degradable and burning leads to toxic materials. Normally, the steel wire would rust away, but the polymer coating prevents this. If the wire is thrown away as such, decomposition of polymer and steel wire takes a very long time resulting in a lot of long lasting and toxic waste, and a risk to the local environment.

Another problem arises when hazardous material, such as polymer coatings, need to be separated from the steel wire, e.g. before combustion or when recycling. This is a tedious job which is hardly ever applied. This is also not commercially or economically feasible.

Bio plastics that are biodegradable and/or compostable, e.g. plastics synthesised by corn, are known in the art. Bio plastics, such as polylactide acid (PLA) have been used in the field of medicine. The high cost of the material prevented it from being used in other fields. Due to technological advances, however, the ecological advantages offered by bio plastics have now become available at a competitive price.

Bio plastics are commonly used e.g. in plastic bags, food-industry and horticulture, and also in medical instruments. The latter two applications are mainly aiming at slow biodegradation of the bio plastics (coating) during the lifetime of the product. Other applications aim at biodegradation after use of the product, whereby the product may not show decomposition during its lifetime.

However, such bio plastics materials exhibit the drawback of being stiff and brittle and they cannot be used for applications where resilient and softness properties are required. Therefore, bio plastics are often mixed with other polymers or plasticizers that enhance the elasticity properties, hereby however also decreasing the biodegradability and/or compostability.

A problem with bookbinding wires is the spiral or helical binding form. The polymer coating needs to have specific elasticity properties to be able to withstand the torsions of the wire when manufactured and handled.

Therefore there is a need for new bookbinding wires and paperclips, having the same resilient properties as conventional polymers, that can be safely, easily and cheaply disposed of after use.

### DISCLOSURE OF INVENTION

It is an object of the invention to provide bookbinding wires and paperclips coated with a coating, having the same resilient properties as the conventional coatings, but which can be disposed of with low or even no problem.

It is a further object of the invention to provide bookbinding wires and paperclips that are degradable, biodegradable and/or compostable.

It is another object of the present invention to provide bookbinding wires and paperclips that combine the features of having a good corrosion protection during their use as bookbinding wire and being degradable, biodegradable and/or compostable once placed in an environment to decompose.

Bookbinding wires and paperclips are a popular binding means to hold sheets of paper together. Bookbinding wires are used in an extensive range of applications, including but not limited to notebooks, catalogues, diaries, sample books, calendars, manuals, etc. Binding by bookbinding wire can very easily be applied with a simple and cheap machine that is available in any office or home environment. Paperclips are used very extensively for holding together smaller numbers of paper.

Bookbinding wire and paperclips are for example made of a steel wire covered by a polymer coating. The steel wire provides strength; the coating prevents the steel wire core from rusting.

Existing bookbinding wires comprise a core wire and a nylon coating, or a core wire and tin layer coating, or a Fe coating covered by a Zn coating further covered by a synthetic coating. Technical characteristics of the coating are low frictional resistance, perfect adhesion to the core, excellent corrosion resistance, good tensile strength, low thickness and light weight.

The core wire is preferably a steel wire.

Bookbinding wire shapes are known in the art, as are also paperclip shapes. In one embodiment bookbinding wire comes in spiral or helical binding. In another embodiment bookbinding wire comes in double loop combs, also called wire-o or looped wire. The wire binding element is formed from a length of wire which is bent to form a series of curved, hairpin shaped prongs to hold the paper. The bookbinding wires and paperclips of the present invention are suitable for any known or future bookbinding or paperclip folding method or shape.

Bookbinding wires and paperclips come in all kinds of colors, which are added to the polymer coating.

In a first embodiment the invention provides a wire comprising a bio plastics material for use as a bookbinding wire or paperclip.

Preferably this wire is a metal wire having a bio plastics coating.

The coating is a closed coating offering said wire a good corrosion protection when exposed at normal ambient conditions during use as bookbinding wire or as paperclip. The coating is degradable, biodegradable or degradable once the wire is placed in an environment suitable for decomposition of said coating.

This means that the wire according to the present invention combines the features of having a good corrosion protection during its use as bookbinding wire or paperclip wire, and that the wire is degradable, biodegradable or compostable once the wire is placed in an environment suitable for decomposition of the coating.

The coating must be such that no degradation at normal ambient conditions for a bookbinding wire or for a clip can be observed. In addition when exposed at normal ambient conditions the coating offers the wire a good corrosion protection. To test the corrosion resistance of the wire, the wire is exposed to an environment at a temperature of 40° and a relative humidity of 100%. After 500 hours exposure no white rust or dark brown rust could be observed.

The corrosion protection of the wire according to the present invention during the use as bookbinding wire or as paperclip wire, is obtained as the coating forms a closed coating.

With “closed” coating is meant a coating that is covering the wire fully, i.e. that is covering the wire 100% or substantially 100%. For a person skilled in the art it is clear that some defects can be present in the coating.

Normal ambient conditions for a bookbinding wire are the environmental conditions such as pressure, temperature, relative humidity that are normal for a given location.

Once brought in an environment suitable for decomposition of the coating, holes are formed in the coating allowing said environment to form rust on the steel through said holes till after a certain period in time the coating will be completely decomposed.

An “environment suitable for decomposition of the coating” according to the present invention is any environment other than an ambient environment. This may be e.g. damp environment, a compost heap or a burning oven. Decomposition may be established in e.g. 75 days.

Bio plastics have great ecological advantages: they are derived from renewable sources and decompose by microorganisms without leaving any residue or giving rise to toxic byproducts. The same amount of carbon dioxide that is given off when incinerated or decomposed, is absorbed from the atmosphere by the raw product. There is no increase of carbon dioxide, and thus no greenhouse gas emissions. Moreover, the cost of bio plastics is such that it has become competitive for use in many applications.

The term “bio plastics” covers a new generation of degradable, biodegradable and/or compostable plastics derived from renewable raw materials such as starch (e.g. corn, potato, tapioca), cellulose, soy protein, lactic acid or any other. Bio plastics are not hazardous in production and decompose in the environment when discarded into carbon dioxide, water and biomass.

Corn starch is currently the main raw material being used in the manufacture of bioplastic resins. Mater-Bi and PolyActide (PLA), both made from corn-starch, are currently the two main resins (raw materials) being used today in the production of compostable and biodegradable plastics and are certified for compostability under standards set by international organizations. The field of bio plastics is constantly evolving with new materials and technologies being worked on and being brought to market. In one embodiment the present invention relates to the use of any of such bio plastics in coatings for bookbinding wires and paperclips.

In one particular embodiment said bio plastics material is a biodegradable material.

In another embodiment said bio plastics material is a compostable material.

In yet another embodiment of the present invention said bio plastics material coating a steel wire is a degradable material.

The term “biodegradable material” is material which will degrade from the action of naturally occurring microorganism, such as bacteria, fungi etc. over a period of time. There is no requirement for leaving no toxic residue, and no requirement for the time it needs to take to biodegrade. A biodegradable plastic has the ability to break down, safely and relatively quickly, by biological means, into the raw materials of nature and disappear into the environment. These products can be solids biodegrading into the soil (which we also refer to as compostable) or liquids biodegrading into water. Biodegradable material is intended to break up when exposed to (naturally occurring) microorganisms such as bacteria, fungi etc. over a period of time.

The term “compostable material” is material which is capable of undergoing biological decomposition in a compost sit, such that the material is not visually distinguishable and breaks down to carbon dioxide, water, inorganic compounds, and biomass, at a rate consistent with known compostable materials (e.g. cellulose), and leaves no toxic residue (American Society for Testing & Materials (ASTM)).

In order for a material to be called compostable, three criteria need to be met:

a) biodegrade or break down into carbon dioxide, water, biomass at the same rate as cellulose (paper);
b) disintegrate so that the material is indistinguishable in the compost; and
c) eco-toxicity meaning that the biodegradation does not produce any toxic material and the compost can support plant growth.

“Degradable material” is material which will undergo a significant change in its chemical structure under specific environmental conditions resulting in a loss of some properties.

Viewed from a particular point of view, an embodiment of the bio plastics material is degradable, biodegradable or compostable for at least 75%, preferably at least 80%, more preferably at least 85%, yet more preferably at least 90%. In a preferable embodiment the bio plastics coating is 95% degradable, biodegradable or compostable. The coating may e.g. comprise 95% bioplastic and 5% other polymer enhancing other characteristics like distortion or elongation.

In a most preferred embodiment said bio plastics coating is 100% degradable, biodegradable or compostable.

In one embodiment said coating comprises polylactide acid (PLA).

In yet another embodiment said coating comprises a composition of bio plastics and conventional polymers.

In a specific embodiment said coating comprises a mix or composition of different bio plastics. One bio plastics material may have more favourable features, such as e.g. elasticity, while the other may be more compostable. In yet another embodiment said coating of bio plastics further comprises a color masterbatch.

In another embodiment said coating may be mixed with plasticizers, dyes and/or lubricants.

In one embodiment said coating has an elongation of at least 4%, preferably 8%.

In an alternative embodiment said steel wire is covered with an intermediate metallic coating. In one embodiment said metallic coating is a copper, copper alloy, zinc, zinc alloy, nickel, nickel alloy, tin or tin alloy.

In a further embodiment the diameter of said steel wire is at least 0.2 mm and the thickness of said coating is at least 20% of the steel wire thickness. In one embodiment the total diameter of the steel wire with the coating is lower than 5 mm. In a preferred embodiment the total diameter of the steel wire with the coating is lower than 3 mm, and may vary between 0.60 mm and 1.60 mm.

In yet a further embodiment the steel wire is a low carbon steel wire with a carbon content below 0.20 wt %.

In this embodiment the steel wire has preferably a carbon content ranging between 0.04 wt % and 0.20 wt %. The complete composition of the wire rod may be as follows: a carbon content of 0.06 wt %, a silicon content of 0.166 wt %, a chromium content of 0.042 wt %, a copper content of 0.173 wt %, a manganese content of 0.382 wt %, a molybdenum content of 0.013 wt %, a nitrogen content of 0.006 wt %, a nickel content of 0.077 wt %, a phosphorus content of 0.007 wt %, a sulfur content of 0.013 wt %.

In another embodiment the steel wire is a high carbon steel wire with a carbon content above 0.25 wt % and lower than 1.0 wt %.

The steel wire is highly mechanically deformed. In a specific embodiment, the mechanically deformed steel wire forms a spiral binding or a double loop comb.

The thickness of the coating may determine the decomposing rate or environment: the thicker the coating, the longer it takes to decompose. This may depend on the application of use. For use in the paper industry, the environment is not very threatening for decomposition or rusting, a thin layer may suffice to cover the core wire. For specific use in a more humid environment, such as in archives, a thicker layer may be more suitable. In a further aspect the invention provides a bookbinding wire or paperclip of steel wire provided with a bio plastics coating, according to any of the previous embodiments.

In yet a further aspect the invention provides a bookbinding wire or paperclip of steel wire provided with a degradable, biodegradable or compostable coating, according to any of the previous embodiments.

Once the coated wire according to the invention is no longer needed, it can be subjected to burning or decomposition in a suitable medium. The degradable, biodegradable or compostable coating will burn without being toxic, or will decompose naturally over time, and the core wire will rust away.

Although steel wire covered with a degradable, biodegradable or compostable coating is protected from rust, the degradable, biodegradable or compostable coating will decompose with the passage of time. This is accomplished by a damp environment, e.g. damp soil or a compost heap, wherein the coating is decomposed by microorganisms, without leaving any residue or toxic byproducts. A hole will open up partly, hereby exposing the steel wire to water and condense allowing the formation of rust. As time passes further on, decomposition of the degradable, biodegradable or compostable coating continues as does the rusting of the steel wire. Finally the degradable, biodegradable or compostable coating and the steel wire decomposes and disappears.

The invention further provides a method for environmentally safe decomposing of bookbinding wires or paperclips comprising a bio plastics, degradable, biodegradable or compostable coating as described above. The method comprises the steps of

a) placing said wires or paperclips in an environment suitable for decomposition of the coating in order to form holes in said coating,
b) allowing said environment to form rust on the steel through said holes, and
c) waiting until the coating and the steel wire have completely decomposed.

An “environment suitable for decomposition of the coating” according to the present invention is any environment other than an ambient environment. This may be e.g. damp environment, a compost heap or a burning oven. Decomposition may be established in e.g. 75 days.

### BRIEF DESCRIPTION OF FIGURES IN THE DRAWINGS

FIG. 1 shows a cross-section of a wire covered with a bio plastics resin.

FIG. 2 shows a cross-section of a wire covered with a bio plastics resin and an intermediate layer.

FIG. 3 shows a spiral loop bookbinding wire.

FIG. 4 shows a bookbinding wire with double loop combs.

FIG. 5 shows a paper clip.

### MODE(S) FOR CARRYING OUT THE INVENTION

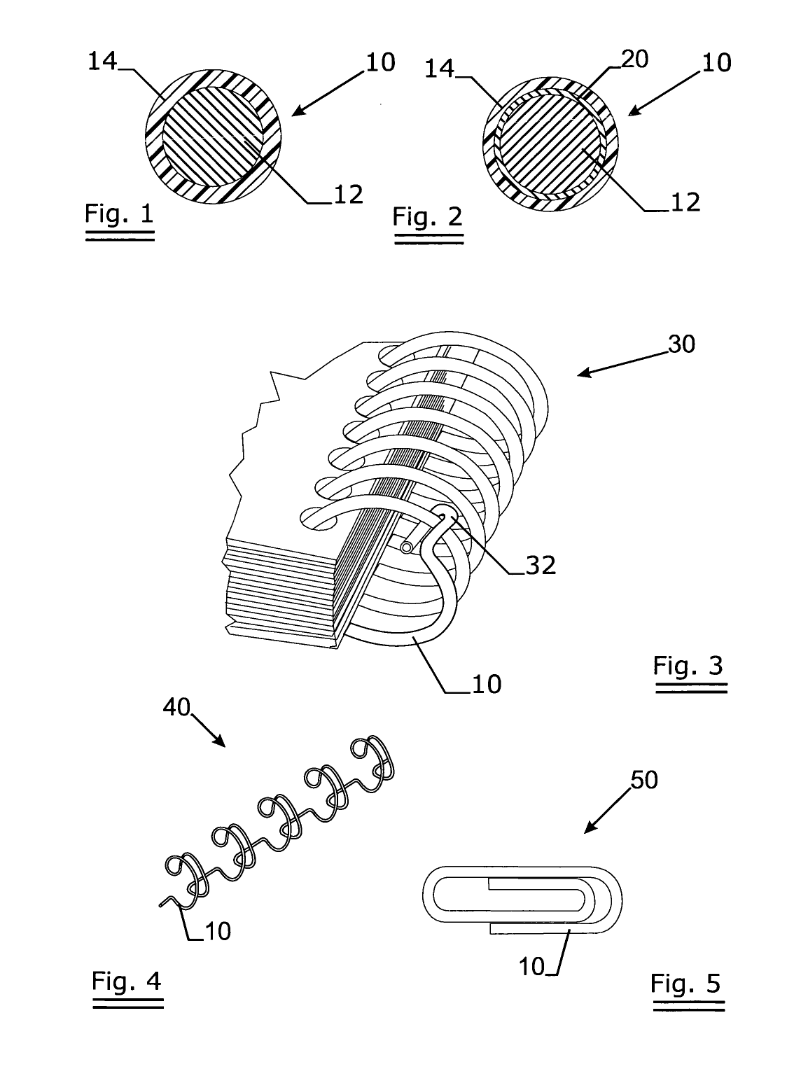

FIG. 1 shows a wire 10 having a steel wire core 12 covered with a bio plastics coating 14. The diameter of the steel core ranges from 0.60 mm to 1.60 mm. The thickness of the coating ranges from 0.020 mm to 0.30 mm.

FIG. 2 shows an alternative where the steel wire core 12 is also covered with a bio plastics coating 14. Additionally a superior corrosion resistance is ensured by an intermediate metallic layer 20.

Bookbinding wires 10 typically are highly mechanically deformed in that they take a helical 30 (FIG. 3) or double loop 40 (FIG. 4) binding form. In addition the helical binding form has at its end a hook form 32. On the one hand, the tensile strength of the wire must be very consistent over its length to ensure perfect comb forming. On the other hand, the bio plastics polymer coating must have specific resilience or elasticity properties to be able to withstand the torsions of the wire when manufactured and handled. Important properties for polymer coated bookbinding wires are therefore: low frictional resistance allowing a higher forming speed, which in turn results in a higher efficiency and productivity; perfect adhesion allowing extreme formability; superior corrosion resistance; aesthetic appeal, smoothness and uniformity.

FIG. 5 shows a paper clip 50 made of a wire 10 with a steel core and a bio plastics polymer coating.

### Example 1

### Wire Coated with PLA and Color Masterbatch

A wire was coated with the biodegradable polymer polyactide acid (PLA) (PLA 2002D from NatureWorks®). PLA is derived from naturally-occurring plant sugar (corn starch). PLA has a glass transition temperature of between 55 and 65° C. and a density of 1.25 g/cm³. Besides the advantages listed above, PLA also has a very low degree of toxicity. Furthermore, PLA is excellent for printing on and has great tensile strength, meaning that the coating thickness can be reduced. These are advantageous characteristics for use in the paper industry.

It is common in the paper industry that bookbinding wires and paperclips come with different colors, hereby coding certain documents or just for the aesthetic aspect. For this purpose, color master batches are available in a wide variety of transparent and opaque colors, for use with starch-blend biopolymers, polylactic acid (PLA), copolyesters and other degradable, biodegradable or compostable resins. Examples of providers are SUKANO® and PolyOne Corp®. Color masterbatches may specifically be added for enhancing properties like denesting, antistatic, slip, anti-block, ultraviolet barrier, blue tone and anti-fog types.

It has now been found surprisingly that adding a color masterbatch to pure

PLA greatly improves the mechanical properties of PLA coated wire for use in bookbinding wire and paperclips. As such, these polymers are less brittle and stiff and very suitable for coating bookbinding wires and paperclips

Table 1 lists some test results. Pure PLA (natural 2002D) has an elongation of 4%, which may as such be sufficient to be applied without cracks on helical bookbinding wires in thin coatings. After addition of 2% Bio-RED (color masterbatch) the properties of the coating were strongly enhanced, up to an elongation of 8%.

TABLE 1

| Coating | Elongation |
|---|---|
| PLA natural 2002D | 4.46% |
| PLA + 2% Bio-RED | 8.09% |

Other PLA Masterbatches are e.g. Bio-White, Bio-Black, Bio-Green and Bio-Blue.

The bio plastics coated steel wires of the present invention may also be used in other applications.

A biodegradable coating such as PLA can be applied to the steel wire using the conventional extrusion process.

A biodegradable coating such as PLA gives a good adhesion to the steel wire without the necessity of applying particular adhesives or primers.

The adhesion between the thermoplastic material such as PLA and the steel wire can be evaluated by carrying out the following test. The PLA coating is removed in the longitudinal direction over about 5 cm by means of the sharp side of a knife. By means of the blunt side of the knife the PLA coating is slightly lifted. Finally, the PLA coating is tried to be pulled off the metal member with the fingers. The more difficult the PLA coating can be pulled off, the stronger the adhesion of the PLA to the steel wire. Tests with PLA coating have resulted in an adhesion level of 1 to 2 on a scale of 5.

1. Use of a wire comprising a coating of a bio plastics material as a bookbinding wire or paperclip, said coating being a closed coating offering said wire corrosion protection when exposed at normal ambient conditions during use as bookbinding wire or as paperclip and said coating being degradable, biodegradable or compostable coating once said wire is exposed to an environment suitable for decomposition of said coating.

2. Use according to claim 1, wherein no white rust and no dark brown rust is observed on said wire when exposed during 500 hours to an environment of 40° C. and a relative humidity of 100%.

3. Use according to claim 1, wherein said wire is a metal wire with a bio plastics coating.

4. Use according to claim 1, wherein said coating is degradable, biodegradable or compostable for at least 75%, preferably at least 80%, more preferably at least 85%, yet more preferably at least 90%, most preferably at least 95%.

5. Use according to claim 1, wherein said coating is 100% degradable, biodegradable or compostable.

6. Use according to claim 1, wherein said coating comprises polylactide acid (PLA).

7. Use according to claim 1, wherein said coating further comprises a color masterbatch.

8. Use according to claim 1, wherein said wire is covered with an intermediate metallic coating.

9. Use according to claim 8, wherein said intermediate metallic coating is a copper, copper alloy, zinc, zinc alloy, nickel, nickel alloy, tin or tin alloy.

10. Use according to claim 1, wherein the diameter of said wire is at least 0.2 mm and the thickness of said coating is at least 20% of the wire diameter.

11. Use according to claim 1, wherein the total diameter of the wire is lower than 5 mm.

12. Use according to claim 1, wherein the total diameter of the wire is lower than 3 mm.

13. Use according to claim 1, wherein the wire is a low carbon steel wire with a carbon content below 0.20%.

14. Use according to claim 1, wherein the wire is highly mechanically deformed.

15. A method for environmentally safe decomposing of bookbinding wires or paperclips comprising a wire covered with a coating of a bio plastic material, said coating being a closed coating offering said wire a corrosion protection during its use as bookbinding wire or as paperclip and said coating being degradable, biodegradable or compostable once said wire is exposed to an environment suitable for decomposition of said coating, said method comprising the steps of
a) placing said wires or paperclips in an environment suitable for decomposition of the coating in order to form holes in said coating,
b) allowing said environment to form rust on the steel through said holes, and
c) waiting until the coating and the steel wire have completely decomposed.

16. Use according to claim 1, wherein the wire is metal wire.

17. Use according to claim 1, wherein the wire is steel wire.
